(19) United States
(12) Patent Application Publication
(10) Pub. No.: US 2004/0080769 A1
(43) Pub. Date: Apr. 29, 2004

(54) Image processing device and image processing method

(75) Inventors: Mari Kodama, Ebina-shi (JP); Ryuichi Ishizuka, Ebina-shi (JP); Yasushi Nishide, Ebina-shi (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 10/390,704

(22) Filed: Mar. 19, 2003

(30) Foreign Application Priority Data
Oct. 28, 2002 (JP) 2002-313071

(51) Int. Cl. G06F 15/00; G06F 3/12

(52) U.S. Cl. 358/1.13; 358/1.18; 358/1.9

(57) ABSTRACT

The present invention provides an image processing device and an image processing method which efficiently and effectively use an overprint warning function to make it possible to efficiently check an actual print finish. When an overprint warning function is set, the print server checks whether a trapping function is set in an ON state or not. The print server sets a trapping setting as a warning object when the trapping function is in an ON state. Therefore, the print server extracts an overprint to check whether the object is set as a warning object for a Koverprint and a register mark/caption, and then performs a warning process to the object serving as a warning object and a print setting, so that the print setting is performed to make the selected warning object definite.

### BACKGROUND OF THE INVENTION

1. Field of the Invention

The present invention relates to an image processing device and an image processing method, which performs image processing for printing an image corresponding to image data formed by various applications by a printout device.

2. Description of the Related Art

Desktop Publishing (DTP) has increased in popularity with the digitalization of print processing. In DTP, creation, processing, editing, and the like of an image are performed by using various applications on a processing device such as a personal computer or a workstation to form a page layout. A film for exposing a printing plate is formed on the basis of the page layout (CEPS), or image data is directly written on a printing plate to form a press plate, also known as Computer to Plate (CTP).

When proofing is performed prior to printing using an actual press plate, a page layout is displayed on a monitor, or an image is printed out by a printout device such as a laser printer or a page printer using a WYSIWYG function or the like.

In many applications used in DTP, a overlapped portions of images can often be designated as overprint images. However, when the overprint is designated, the images are displayed on a monitor such that the image on top knocks out the image underneath (hereinafter referred to as “top image” and “underlying image”, respectively). When printing with a printer, as is the case in the display on the monitor, the top image is printed such that the underlying image is knocked out, hence the overprint cannot be easily checked by a proofed print formed by the printer.

In order to check overprint designation, separate images of CMYK colors are formed, and the separate images of the respective color components must be output by monochrome printing and visually checked. For this reason, proof operation of a page layout is complex and a high degree of skill is required. In addition, although printers exist which can perform simulation of overlapping printing of respective color images, such as printed matter using a machine plate, such printers are expensive, and a long period of time is required to print out the images.

For this reason, there have been proposals of forming color proofs such that different exposure states (finishes) are obtained by black (black print) image data and image data obtained by overlapping other colors on a black color (for example, see Japanese Patent Application Laid-Open (JP-A) No. 2000-352813).

However, simply checking the overlapped colors on black does not always provide appropriate print simulation.

Overprint images include a plurality of patterns, so that one of the plurality of patterns is selected depending on the intended purpose. When an overprint is designated, images are printed out with a printout device. In this case, a top image (color) and an underlying image (color) are generally input such that the top image knocks out the underlying image.

For example, when magenta is overprinted on cyan, the state obtained when an image is knocked out by another image is obviously different from the state obtained when images are overprinted. When this is overlooked in proofing, the difference considerably affects printing when using an actual machine plate.

In K overprinting, in which a black character is put on an underlying color or on a photographic image, or an overprint image such as trapping for preventing a white gap of a boundary between the images, it is preferable not to overlook the changes when proofing. However, there are cases when even overlooking may not affect the actual printed matter.

For this reason, when image data possessing many overprint settings are printed out with a printout device such that the overprinted portion becomes defined, an image which differs visually from the actual image is output, and thus a smooth proof operation cannot always performed.

Depending on the applications, register marks or captions are added such that they are overprinted. In image data to which such a setting is added, clearly defining all overprints can often hinder smooth proofing operation.

### SUMMARY OF THE INVENTION

The present invention is made in consideration of the above circumstances, and its purpose is to propose an image processing device and an image processing method which can confirm designation of an overprint and can easily check actual print finish.

In order to achieve the above objective, according to one aspect of the invention, there is provided an image processing device for generating Raster data based on image data input together with a drawing instruction from an image processing terminal, including a detection component for detecting whether images are set as an overprint in which images are overlapped on each other on an image on the basis of at least one of the drawing instruction and the image data; a selection component for selecting whether notification is performed for each of the types of overprints in which images are overlapped on each other on an image on the basis of at least one of the drawing instruction and the image data; and a notification component for performing notification of a detection result of the detection component on the basis of the selection performed by the selection component.

According to the invention, on the basis of at least one of the drawing instruction and the image data, an overprint in which images are overlapped on each other on an image is detected by the detection component. The notification component notifies the image processing terminal or a person who requests image processing of the overprint detected by the detection component such that the overprint is defined for the image processing terminal or the person.

In this manner, the image processing terminal or the person who requests image processing can definitely decide that an overprint is designated on a printed matter based on image data. In addition, since this configuration is a simple configuration in which the detection component and a warning component are arranged, the overprint can be easily achieved at low cost.

At the same time, the selection component selects whether notification of the overprint detected by the detection component is performed or not. More specifically, the selection component selects whether overprint warning is performed or not.

When the selection component is arranged to suppress unnecessary notification of an overprint, so that image processing for a proof operation can be made efficient.

The selection component can preferably select whether notification of a trapping process for overlapping the peripheral part of an top image on a underlying image and K overprint and a register mark/caption in which black characters or graphic are overlapped on an image is performed or not. The selection component preferably sets whether notification is performed or not in advance.

The selection component may load information selected on the image processing terminal and select whether notification of an overprint is performed or not.

According to the invention, the image processing terminal selects an overprint to be notified, and sets whether notification of the overprint is performed or not on the basis of the selection result. In this manner, smooth and efficient image processing can be performed.

The detection component may include an extraction component for extracting an top image of the images which are overlapped on each other, and the notification component may include a setting component for setting a processing performed in the image processing component which defines and clarifies the image extracted by the extraction component.

According to the invention, an image processing is performed such that the image extracted by the extraction component is definitely an overprinted image. More specifically, overprint warning is generated on an image.

In this manner, for example, when print output is performed for a proof operation, images to be overprinted are definite, and an appropriate proof operation can be performed. Since it is selected whether overprint warning is performed or not, an image on a printed matter is prevented from being degraded by unnecessary overprint warning, so that a correct proof operation can be performed.

As the setting component, a component for adding an edge line of a predetermined color along the contour of an image extracted by the component or a component for converting the image extracted by the extraction component into an image of a predetermined color may be used. At this time, the converted color or the color of the edge line may be a preset color, or designated by the image processing terminal.

As the setting component, a component for performing a setting such that Raster data for deleting an image extracted by the extraction component is generated may be used. In contrast to this, a component for performing a setting such that Raster data obtained by deleting at least the edge of an image extracted from the extraction component may be used.

More specifically, as the setting component, a component for performing a setting such that a printed matter for notification is printed out may be used. At this time, this setting may be performed such that a normal printed matter based on a drawing instruction and image data is also printed out. In this manner, the image to be overprinted can be definitely and reliably visually checked.

The notification component may include a display control component for outputting a message to the image processing terminal such that the message can be displayed on the image processing terminal.

According to the invention, overprint warning is performed by displaying a message on the monitor of the image processing terminal. In this manner, without performing image processing, it can be definitely known that images include an overprinted image. On the basis of the notification (warning), an overprint to be notified is selected by the selection component, so that an efficient proof operation can be performed.

As the display control component, a component for displaying an input request of processing designation to an image detected by the detection component on the image processing terminal is more preferably used, or a component which can display a print-out image depending on the image data on the image processing terminal may be used.

According to another aspect of the invention, there is provided an image processing method for generating Raster data based on image data input together with a drawing instruction from an image processing terminal, comprising the steps of: (a) detecting whether images are set as an overprint in which images are overlapped on each other on an image or not on the basis of at least one of the drawing instruction and the image data; (b) selecting whether notification is performed for each of the types of overprints in which images are overlapped on each other on an image or not on the basis of at least one of the drawing instruction and the image data; and (c) performing notification of a detection result obtained in the step (a) on the basis of the selection performed in the step (b).

As described above, according to the invention, when an image to be overprinted is detected, notification is performed such that the corresponding image is definite. For this reason, the image to be overprinted can be correctly determined. At this time, in this invention, since the overprint to be notified can be selected, an image processing result such as a printed matter can be prevented from being cumbersome and indefinite, and efficient image processing can be advantageously performed.

### BRIEF DESCRIPTION OF THE DRAWINGS

FIG. 1 is a schematic diagram showing the configuration of an essential part of a print server applied to an embodiment of the present invention.

FIG. 2 is a schematic diagram showing a trapping process serving as an example of an image to be overprinted.

FIG. 3A is a schematic diagram showing an image to be overprinted.

FIG. 3B is a schematic diagram showing color conversion of an image to be overprinted.

FIG. 3C is a schematic diagram showing deletion of an image to be overprinted.

FIG. 3D is a schematic diagram showing extraction of an image to be overprinted.

FIG. 3E is a schematic diagram in which an outline is added to an image to be overprinted.

FIG. 4 is a schematic diagram showing an example of a user interface used for setting an overprint warning.

FIGS. 5A and 5B are flowcharts of a printing process using an overprint warning function in the embodiment of the present invention.

FIGS. 6A and 6B are a flowchart of an example of an overprint warning process.

FIG. 7 is a schematic diagram showing an example of a warning message.

FIG. 8 is a diagram showing an example of a display of processing designation for an image to be overprinted.

FIG. 9 is a schematic diagram showing another example of the warning message.

### DESCRIPTION OF THE PREFERRED EMBODIMENTS

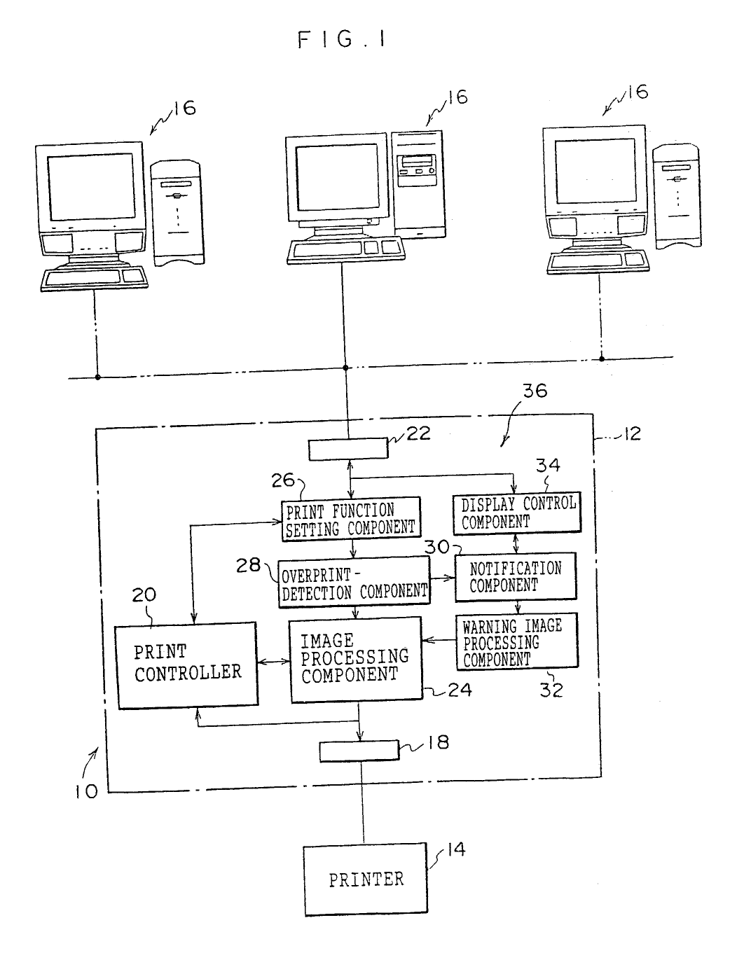

Embodiments of the present invention will be described below with reference to the accompanying drawings. FIG. 1 shows a schematic configuration of a print system 10 applied to an embodiment of the present invention. The print system 10 comprises an image processing device 12 having a configuration obtained by adding a PCI board having a predetermined function to a personal computer (PC) with a standard configuration. A printer 14 serving as a print-out device is connected to the image processing device 12, so that an image processed by the image processing device 12 can be printed out.

In addition, personal computers, workstations, and the like are connected as client terminals 16 to the image processing device 12. The client terminal 16 can be used in DTP, which performs image processing such as formation, processing, and editing of an image by using various applications. The image processing device 12 performs a printing process based on instructions input from the client terminals 16.

More specifically, in the print system 10, the image processing device 12 also has a print server function (hereinafter referred to as a “print server 12”). The print system 10 can comprise a plurality of printers 14 connected to the print server 12, or a system in which a plurality of client terminals 16 are connected to the print server 12 through a LAN or WAN network or the like.

In the print server 12 used in this embodiment, an external memory such as a ROM, a RAM, or an HD is arranged. The print server 12 is operated by an operating program stored in the ROM, and has a common configuration which performs processing to a system graphic, an image, characters, a table, or the like on the basis of the program stored in the ROM or the external memory.

The print server 12 comprises an input device such as a keyboard or a mouse and a display device such as a CRT display. In the print server 12, a printing process can also be performed to a display image on the display device (WYSIWYG function).

In the print server 12, a bidirectional interface 18 such as an Ethernet (R) and a print controller 20 are arranged, and the print controller 20 is connected to the printer 14 through the bidirectional interface 18. There is also an image processing component 24 is formed in the print server 12.

The image processing component 24 generates Raster data from image data. This Raster data is controlled by the print controller 20 and output to the printer 14, so that a printed matter based on the image data can be obtained.

Meanwhile, a network interface 22 is arranged in the print server 12. The network interface 22 receives an image file and a drawing instruction as a print job from the client terminal 16 through the network interface 22. The print server 12 has a general configuration, which performs a printing process base on the drawing instruction.

The client terminal 16 uses various DTP applications such as Photoshop and Illustrator (product names of Adobe Systems Incorporated in the U.S.A) and QuarkXPress (product name of Quark in the U.S.A.) to perform image processing such as formation, processing, and editing of an image, and forms image data of a page layout or the like (hereinafter referred to as a “page layout”).

The page layout formed by the client terminal 16 is used to form a film used in exposure of a printing plate in a color electric prepress system (CEPS), or is used in exposure of a printing plate in direct plate making (CTP). A printing process is performed by a press plate formed on the basis of the page layout.

In DTP, prior to formation of a press plate based on a page layout, proof printing for forming a proofing printed matter (proof) called a color proof or the like (hereinafter referred to as a “proof”). The page layout is proofed based on the proof printing. In the print system 10 applied to this embodiment, formation of the proof is performed.

When the proof printing is performed, a drawing instruction and an image file including a page layout are output from the client terminal 16 to the print server 12. In this manner, the print server 12 performs the printing process based on the page layout.

The page layout input from the client terminal 16 may be a page layout of CMYK format, RGB format, or a page layout using both the formats. In the image processing component 24, Raster data of Y-, M-, C-, and K-colors are generated from the page layout and output to the printer 14.

A print function setting component 26 is arranged in the print server 12. The print function setting component 26 reads a setting of a printing function on the drawing instruction of the print job to set a printing function used when image processing and a printing process are performed. The setting of the printing function is not limited to the setting on the print job. For example, an application name used for forming a print job by the print server 12 can be extracted, and a set value which is set and stored in advance on the basis of the extraction result may be used in the setting of the printing function.

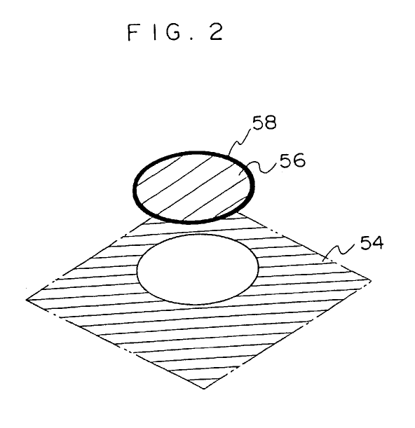

As shown in FIG. 2, in some page layouts, an underlying image 54 is knocked out, and a top image 56 is fitted into a cutout a portion of the underlying knocked out image 54. At this time, in order to fill a gap between the images 54 and 56, a trapping process such as spread process for widening the edge line of the image 56 or a choke process for narrowing the knock-out area of the underlying image is performed. In some application such as QuarkXPress, even though the trapping process is set, a trap portion is not actually drawn.

In the print function setting component 26, it is assumed that, for example, the underlying image 54 is knocked out and that the top image 56 is fitted in the knock-out portion. In this case, when the line width of an edge line 58 which buries the trap portion between the images 54 and 56 is set, the edge line 58 is considered as an overprint in the overprint warning function.

On the page layout, a K overprint in which a black character or a graphic is overprinted on an image may be designated. Some application, which forms the layout, has a function of automatically overprinting a register mark, a caption, or the like formed outside the area of the page layout (margin).

As shown in FIG. 1, an overprint detection component 28 is arranged in the print server 12.

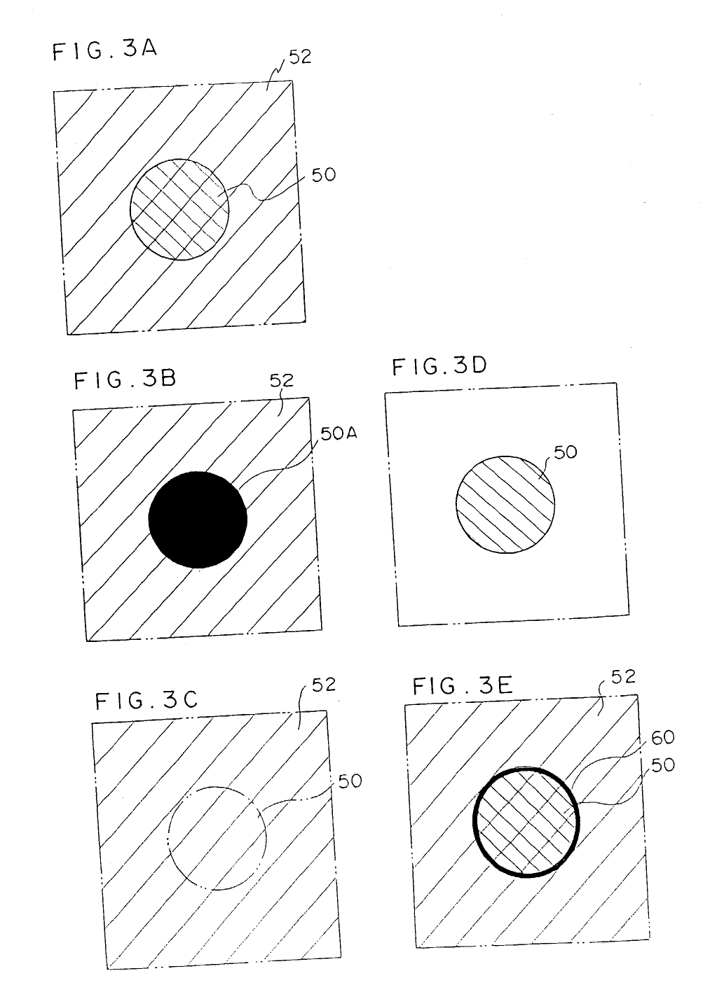

The overprint detection component 28 can detect whether an overprint for overlapping image on each other on a page layout is designated on the basis of an image file obtained before, e.g., Raster data is generated. More specifically, the overprint detection component 28, for example, as shown in FIG. 3A, can detect whether the page layout include an area in which an top image 50 is overlapped on a underlying image 52 or not.

The overprint detection component 28 can detect whether a K overprint is designated from, e.g., an image file or not and whether overprint designation of a register mark, a marginal caption, or the like is made or not.

In the print server 12, as the notification component, the notification component 30 and a warning image processing component 32 are arranged. When the overprint detection component 28 detects the overprint designation from the image file, the notification component 30 notifies the client terminal 16 which requests image drawing that the overprint image exists.

At this time, in the notification component 30, a predetermined notification message is displayed on the monitor of the client terminal 16 by using a display control component 34. The display control component 34 displays a screen which request selection of a process to the overprint.

The warning image processing component 32 performs a predetermined process to the overprint image detected by the overprint detection component 28. This process, for example, as shown in FIG. 3B, converts the top image 50 of the overlapped images 50 and 52 into an image 50A which is painted with a warning color or an arbitrary set color such as magenta.

In the warning image processing component 32, a print output obtained by overlapping the upper and underlying images and a print output obtained by deleting the top image can be set. More specifically, in addition to a normal print output (for example, an image shown in FIG. 3A) obtained by the printer 14 based on image data, as a warning page, as shown in FIG. 3C, a printed matter in which the image 50 is deleted or, as shown in FIG. 3D, a printed matter from which the image 50 is extracted is set.

As shown in FIG. 3E, in the warning image processing component 32, a setting in which an edge line 60 along the edge of the 50 is framed in a warning color or a designated color can also be performed. The edge line 58 in the trapping process is set like the edge line 60 of the image 50 such that the color of the edge line 58 is converted in the warning color or the arbitrary set color.

In the image processing component 24, a process such as an image conversion (generation of Raster data) process is performed on the basis of the setting of the warning image processing component 32. The image processing component 24 can apply a conventional known arbitrary configuration. In this embodiment, a description of the image processing component 24 will be omitted.

On the other hand, the respective client terminals 16 connected to the print server 12 can set whether overprint warning is performed in a print-out state or not.

In this case, a setting of an overprint warning function in the client terminal 16 and a process for an overprint warning function in the print server 12 based on the setting will be described below.

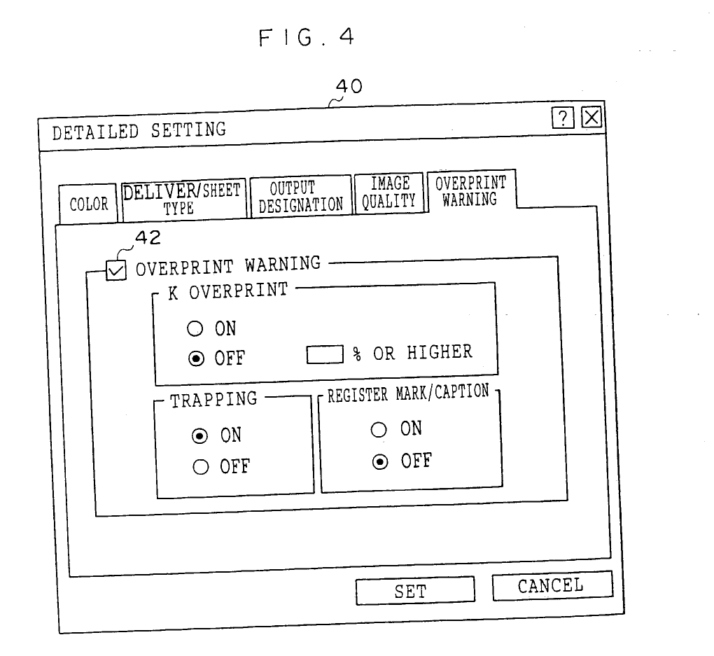

FIG. 4 shows an overprint warning setting window 40 serving as an example of a user interface for performing the setting for the overprint warning. This overprint warning setting window 40 can be displayed when a print-out operation of a page layout by the print server 12 is requested by the client terminal 16.

In the overprint warning setting window 40, a check box 42 is marked to make it possible to select whether overprint warning is performed or not.

In the overprint warning setting window 40, the check box 42 is marked to set the overprint warning. Furthermore, in the overprint warning setting window 40, it can be selected whether warning (overprint warning) is performed for each of a K overprint, trapping, and a register mark/caption. For the K overprint, the density of the K color (black) used in the overprint can be set. FIG. 4 shows a state in which the overprint warning is set and only warning for the trapping from warning for the K overprint, the trapping, and the register mark/caption is selected.

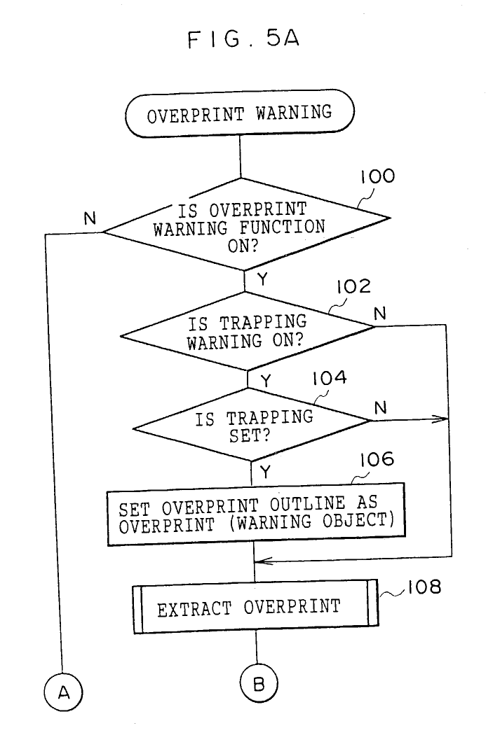

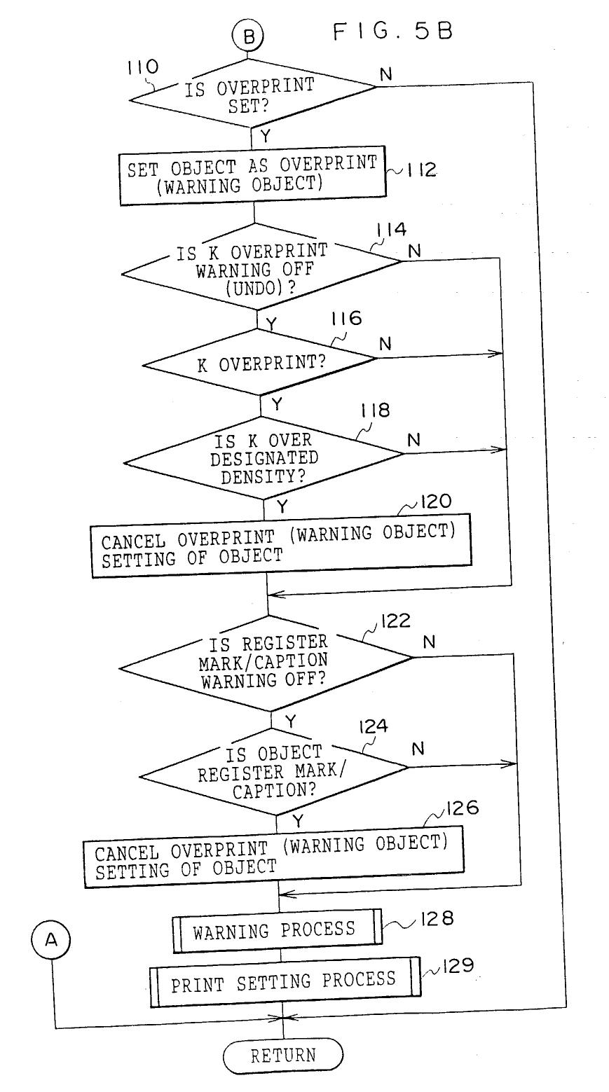

FIGS. 5A and 5B illustrate an overprint warning process executed by the print server 12. This flow chart is started when the print server 12 receives a print job output from the client terminal 16 and executes a printing process for the print job. In the first step 100, the print server 12 checks whether the overprint warning function is set in an ON state or not. More specifically, the print server 12 checks whether the check box 42 is marked or not in the overprint warning setting window 40 (see FIG. 4).

In this case, the overprint warning function is in an ON state, an affirmative determination is made in step 100 to execute the overprint warning process.

In the overprint warning process, the print server 12 checks in step 102 whether trapping warning is set (ON) or not. At this time, when the trapping warning is set, an affirmative determination is made in step 102 to shift to step 104.

In step 104, for example, the print server 12 checks whether a trapping setting is performed or not on the basis of a print file (page layout). When the trapping setting is performed, an affirmative determination is made in step 104 to shift to step 106 and to set an edge line (edge lines 58 and 60) added in the trapping setting on an overprint (object of overprint warning).

Thereafter, in step 108, overprint detection and extraction (overprint extraction) of an overprint image (object) are performed. At this time, the edge line 58 used in the trapping process is also detected as an overprint. The detection of the overprint and the detection of the edge line 58 can be achieved by a conventional known arbitrary configuration.

In the next step 110, the print server 12 checks whether an overprint is detected or not. More specifically, the print server 12 checks whether an overprint is set or not. When the overprint is extracted, an affirmative determination is made in step 110 to shift to step 112 and to set an image (object) as an overprint image (object of overprint warning).

Thereafter, in step 114, the print server 12 checks whether the K overprint warning is in an OFF state or not. At this time, when the K overprint warning is in an OFF state (not warning), an affirmative determination is made in step 114 to shift to step 116.

In this step 116, the print server 12 checks whether a Kover print is detected or not. When the K overprint is detected, an affirmative determination is made in step 116 to shift to step 118 and to check whether a K color set in the overprint has a concentration which is equal to or higher than a designated concentration.

When the concentration is equal to or higher than the designated concentration, an affirmative determination is made instep 118 to shift to step 120 and to release the object (image) detected as the K overprint from the object of the overprint warning.

In step 122, the print server 12 checks whether overprint warning for a register mark/caption is not selected (OFF) in the overprint warning setting on the client terminal 16. When the overprint warning is not selected for the register mark/caption (OFF), an affirmative determination is made in step 122 to shift to step 124 to check whether an object is detected as the register mark/caption.

When the object is detected as the register mark/caption, an affirmative determination is made in step 124 to shift to step 126 and to release a setting of overprint warning of the object detected as the register mark/caption. More specifically, the object of the register mark/caption is eliminated from the objects of overprint warning.

In this manner, when a warning object to which detection of an overprint and overprint warning are performed is set, a warning process is performed in step 128, and a print setting process based on the warning process is executed in step 129.

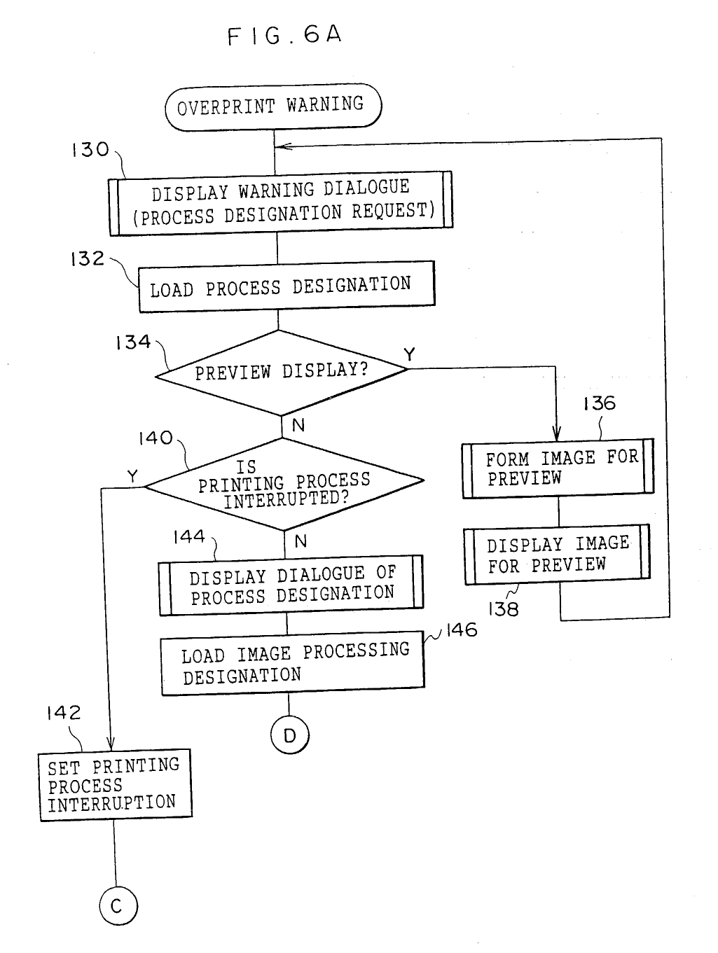

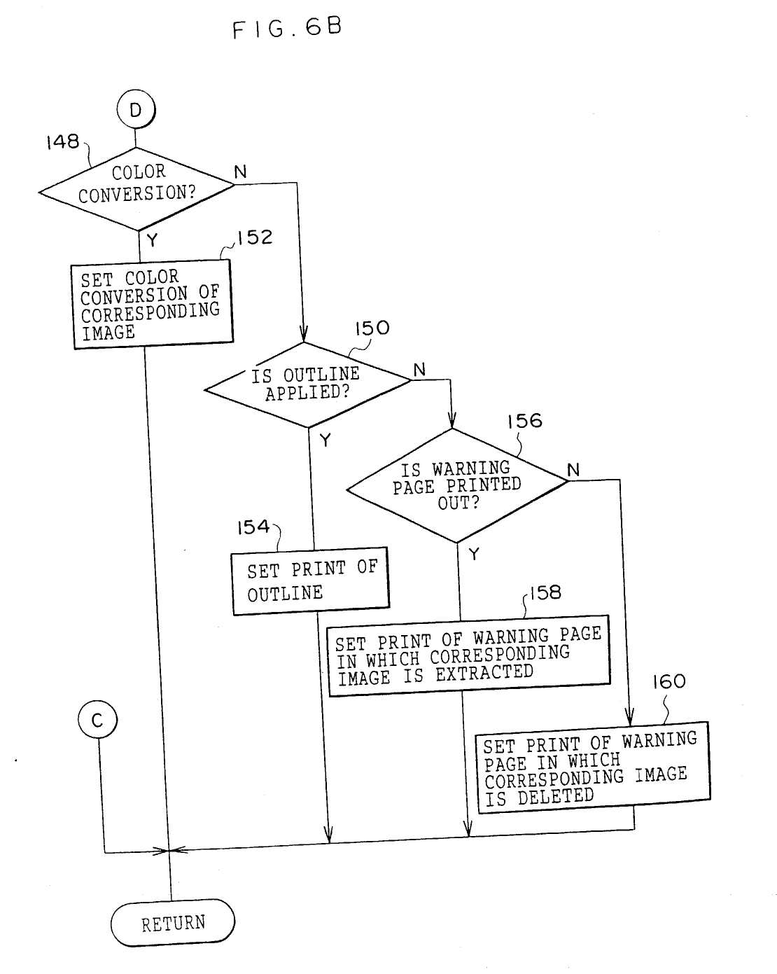

FIGS. 6A and 6B show the outlines of the warning process and the print setting (corresponding to steps 128 and 129 in FIGS. 5A and 5B) to an overprint. More specifically, overprint warning is executed by setting the overprint warning and detecting an image (object) subjected to the overprint warning. In the following description, it is assumed that the overprint warning is set and that the overprint warning is selected for the trapping selected from the K overprint, the trapping, and the register mark/caption.

In this flow chart, in the first step 130, the monitor of the client terminal 16 which requests a printing process to a print job displays that it is notified that an image subjected to the overprint warning is detected. More specifically, the dialogue of a warning message is displayed on the client terminal 16, which requested the print job processing, and notifies the user that an object of the overprint warning is detected.

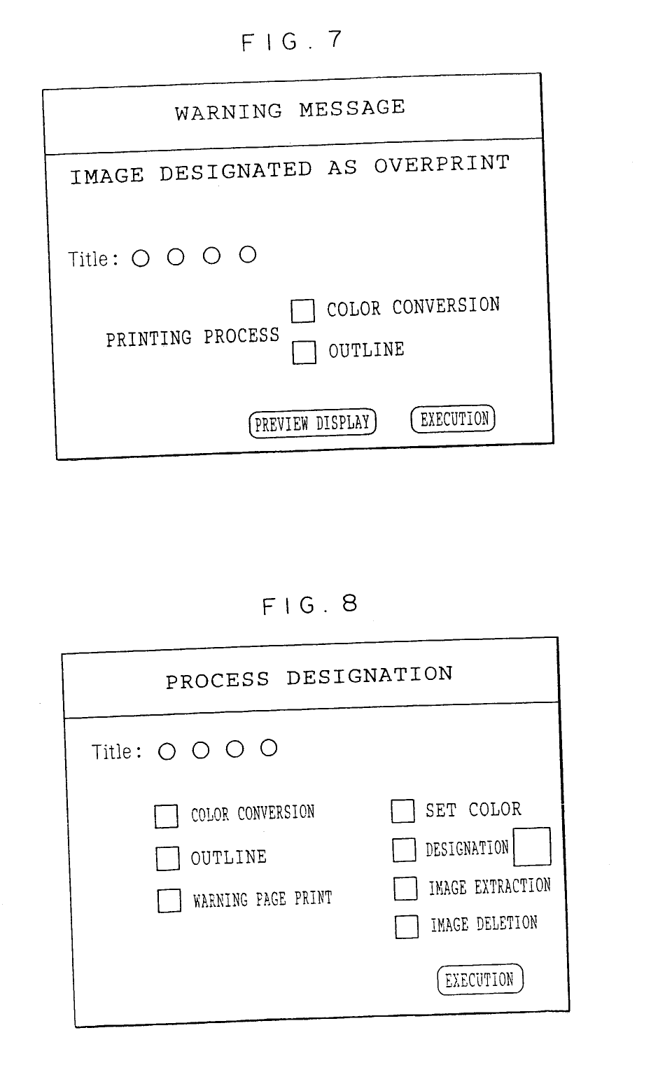

FIG. 7 shows an example of a dialogue of the warning message. In this dialogue, the warning message and a selection menu for selecting whether the printing process is continued or not are displayed, and an input of process designation based on the selection menu is requested. A preview display can be selected on this dialogue.

When the process designation is input from the client terminal 16 on the basis of the warning dialogue, the print server 12 shifts to step 132 in the flow chart shown in FIGS. 6A and 6B to load the input process designation. Thereafter, in step 134, the print server 12 checks whether the preview display of the corresponding page layout (print page) is designated or not.

At this time, when the preview display is designated, an affirmative determination is made in step 134 to shift to step 136 and to perform image conversion for preview. The preview image is displayed on the monitor of the client terminal 16 (step 138). The preview display is performed such that an image to be overprinted is definite.

When the preview display is not designated, or when the preview display is completed to load process designation to be input, a negative determination is made in step 134 to shift to step 140. In step 140, it is checked whether the printing process is interrupted or not.

When the interruption of the printing process is set, an affirmative determination is made in step 140 to shift to step 142, and the interruption of the printing process for the print job is set. When the printing process is interrupted, the print server 12 checks whether the received print job is stored. When the print job is not stored, the received print job is deleted to end the process. When the storage of the print job is designated, the corresponding print job is stored in an external memory such as an HDD arranged in the print server 12 to end the process.

In this manner, the print job is stored to partially change the page layout. When a new printing process is requested, a data transfer time can be shortened.

On the other hand, the continuity of the printing process is designated, a negative determination is made in step 140 to shift to step 144. In step 144, a dialogue for requesting an input of a detailed setting of the process is displayed on the monitor of the client terminal 16.

FIG. 8 shows an example of the dialogue. As processes for an image to be overprinted, for example, color conversion of the image, an application of the edge line 60 (in the following description, it is assumed that the “edge line 60” includes the “edge line 58”), and designation of a print-out operation of a warning message or the like can be performed. When the color conversion of the image or the application of the edge line 60 is selected, a present warning color (e.g., magenta) or an arbitrary color can be designated.

When normal printing and printing of a warning message are designated, a setting is performed such that, in the normal printing, a printed matter from which a corresponding image is removed and a warning page obtained by extracting only the corresponding image are printed out.

When the designation of the printing process is input on the basis of the dialogue, in the flow chart in FIGS. 6A and 6B, the print server 12 loads a process setting in step 146 and checks in step 148 whether the color conversion of the image is designated or not. In step 150, the print server 12 checks whether the application of the edge line 60 is designated or not.

In this manner, when the color conversion of the image is designated, an affirmative determination is made in step 148 to shift to step 152. In step 152, the print server 12 sets a color to be converted on the basis of the loaded process designation and converts the color of the image into the set color to print out the image.

For this reason, the color of the image subjected to the overprint warning is converted into the predetermined color such that the image is definite, and the image is printed out from the printer 14 (for example, see FIG. 3B).

In addition, when the application of the edge line 60 is designated (negative is determined in step 148, and affirmative is determined in step 150), the print server 12 shifts to step 154 to set the color of the edge line 60 on the basis of the loaded process designation, and the edge line 60 having a predetermined width and a predetermined color is printed on the edge of the corresponding image.

In this manner, on the printed matter output from the printer 14, the image subjected to the overprint warning is framed by the edge line 60 such that the image is definite (for example, see FIG. 3E). Since the settings for the edge line 58 of the trapping process are the same in steps 150 and 152, the designation of the color conversion of the image may be deleted on the dialogue.

Negative are determined in steps 148 and 150, the print server 12 shifts to step 156. In step 156, the print server 12 checks whether an image subjected to the overprint warning is extracted as a warning page and printed out or not.

When the printout operation of the warning page is set, an affirmative determination is made in step 156 to shift to step 158. In step 158, the print output of a printed matter in which the image subjected to the overprint warning is deleted and the image subjected to the overprint warning are extracted, and only the corresponding image is printed out.

In this manner, the printed matter in which the image subjected to the overprint warning is deleted and a warning page (for example, see FIG. 3D) from which the corresponding image is extracted are printed out from the printer 14.

In contrast to this, when the printout operation of the warning page is not set, a negative determination is made in step 156 to shift to step 160. In step 160, a setting is performed such that, following a normal print page, the warning page from which the image subjected to the overprint warning is deleted is printed out. For this reason, following the normal printed matter, the warning page (see FIG. 3C) from which the image to be overprinted is deleted is printed out.

In this manner, in the print server 12, when an image subjected to the overprint warning is detected, warning is generated such that the corresponding image is definite, or the image can be printed out such that the image is definite.

Therefore, an expensive printer that can simulate an output from a printing device is not necessary. A printed matter in which an image to be overprinted is definite can be easily output, and appropriate proof can be easily performed.

The print server 12, on the client terminal 16, by using the user interface, can select whether overprint warning is performed or not and conditions for performing the overprint warning. For this reason, unnecessary overprint warning can be suppressed from being performed.

More specifically, in the check of the page layout or the like, when unnecessary overprint warning is generated for an overprint such as a K overprint or a register mark/caption which does not substantially affect the printing process, the operation efficiency is deteriorated in having to cope with the unnecessary warning, and the generation of the overprint warning may be bothersome.

At this time, warning is generated to only an overprint setting, which requires warning, so that the operation efficiency can be improved.

When the images on the page layout include a large number of warning images, an original image becomes indefinite. However, when an overprint that generates warning is selected, the aspect of the original image is suppressed from being damaged, and a proof operation can be efficiently and appropriately performed.

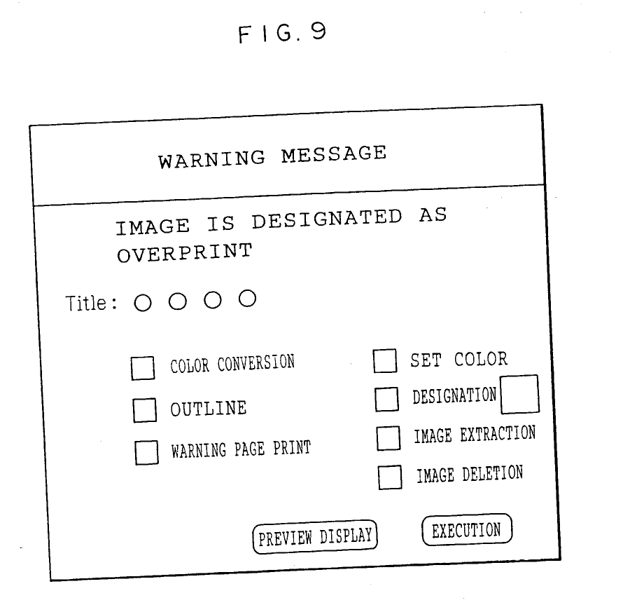

The embodiment described above does not limit the configuration of the invention. For example, in this embodiment, the dialogue (see FIG. 7) of the warning message and the dialogue (see FIG. 8) for process designation are separately displayed. However, for example, as shown in FIG. 9, these dialogues may be displayed as one dialogue.

More specifically, in one dialogue, a message of overprint warning and a process request to an image subjected to the overprint warning may be displayed at once. This configuration is preferable when operation efficiency on the client terminal 16 is considered.

The dialogues shown in FIGS. 7 to 9 show only examples. The display of the overprint warning and an input request of a process setting can be achieved by using a display having an arbitrary configuration. As notification which is performed when an image subjected to overprint warning is detected, not only notification performed by a display on the monitor of the client terminal 16, but also any arbitrary method which makes a corresponding image on a printed matter is definite can be applied.

In addition, in this embodiment, when an image subjected to overprint warning is detected, an input of process designation for this image is requested. However, the invention is not limited to the embodiment. For example, color conversion, application of the edge line 60, or a printing operation of a warning page is preset to the image subjected to overprint warning. When the image subjected to overprint warning is detected, only notification is performed to the client terminal 16 by a dialogue or the like, and the print setting process may be performed on the basis of the process setting.

What is claimed is:

1. An image processing device, which generates Raster data based on image data input with a drawing instruction from an image processing terminal, comprising:
a detection component, which detects whether images are set as an overprint in which image objects are overlapped on an image on the based on at least one of the drawing instruction and the image data;
a selection component, which selects whether notification is performed for each of the types of overprints in which image objects are overlapped on an image based on at least one of the drawing instruction and the image data; and
a notification component, which notifies a detection result of the detection component based on the selection performed by the selection component.

2. The image processing device of claim 1, wherein the selection component loads information selected on the image processing terminal to select whether notification of the overprint is performed.

3. The image processing device of claim 1, wherein
the detection component includes an extraction component, which extracts a top image object of the image objects which are overlapped on each other, and
the notification component includes a setting component, which sets a process for clearly specifying the image object extracted by the extraction component.

4. The image processing device of claim 3, wherein the setting component sets a process of applying an outline of a predetermined color along the contour of the image object extracted by the extraction component.

5. The image processing device of claim 3, wherein the setting component sets a process of converting the color of the image object extracted by the extraction component into a predetermined color.

6. The image processing device of claim 3, wherein the setting component sets a process of deleting the image object extracted by the extraction component.

7. The image processing device of claim 3, wherein the setting component sets a process of deleting an image object except for the image object extracted by the extraction component.

8. The image processing device of claim 1, wherein the notification component includes a display control component for outputting a message such that the message can be displayed on the image processing terminal.

9. An image processing method, which generates Raster data based on image data input with a drawing instruction from an image processing terminal, comprising the steps of:
(a) detecting whether images are set as an overprint in which image objects are overlapped on an image based on at least one of the drawing instruction and the image data;
(b) selecting whether notification is performed for each of the types of overprints in which image objects are overlapped on an image based on at least one of the drawing instruction and the image data; and
(c) notifying a detection result in step (a) based on the selection in step (b).

10. The image processing method of claim 9, wherein
in step (b), information selected on the image processing terminal is loaded to select whether notification of the overprint is performed.

11. The image processing method of claim 9, wherein
step (a) includes the extraction step of extracting a top image object of the image objects, which are overlapped on each other, and
step (c) includes the setting step of setting a process for clearly specifying the image object extracted in the extraction step.

12. The image processing method of claim 11, wherein the setting step sets a process of applying an outline of a predetermined color along the contour of the image object extracted in the extraction step.

13. The image processing method of claim 11, wherein the setting step sets a process of converting the color of the image object extracted in the extraction step into a predetermined color.

14. The image processing method of claim 11, wherein the setting step sets a process of deleting the image object extracted in the extraction step.

15. The image processing method of claim 11, wherein the setting step sets a process of deleting an image object except for the image object extracted in the extraction step.

16. The image processing method of claim 9, wherein the notification step (c) includes the output step for outputting a message such that the message can be displayed on the image processing terminal.
